(19) United States
(12) Patent Application Publication
(10) Pub. No.: US 2025/0112672 A1
(43) Pub. Date: Apr. 3, 2025

(54) MOBILE WIRELESS DEVICE WITH EXPANSION FUNCTION AND ELECTRONIC DEVICE

(71) Applicant: Wistron NeWeb Corporation, Hsinchu (TW)

(72) Inventor: Shih-Hang HUANG, Hsinchu (TW)

(21) Appl. No.: 18/679,801

(22) Filed: May 31, 2024

(30) Foreign Application Priority Data
Sep. 28, 2023 (TW) 112137305

(51) Int. Cl. H04B 7/0404; H04B 1/00; H04M 1/02; H04W 88/06

(52) U.S. Cl. CPC H04B 7/0404; H04B 1/0064; H04M 1/0274; H04W 88/06

(57) ABSTRACT

A mobile wireless device with expansion function is configured to connect a wireless expansion device and includes a plurality of first antennas, a wireless communication module and at least one connecting port. The wireless communication module is connected to the first antennas. The at least one connecting port is connected to the wireless communication module. The at least one connecting port is configured to be detachably connected to at least one second antenna of the wireless expansion device, so that the wireless communication module performs wireless transmission through at least a part of the first antennas and the at least one second antenna.

### RELATED APPLICATIONS

This application claims priority to Taiwan Application Serial Number 112137305, filed Sep. 28, 2023, which is herein incorporated by reference.

### BACKGROUND

### Technical Field

The present disclosure relates to a mobile wireless device and an electronic device. More particularly, the present disclosure relates to a mobile wireless device with expansion function and an electronic device.

### Description of Related Art

In the existing scenario, when a user is outdoors, a mobile wireless fidelity (mobile WiFi (MiFi)) device is used to provide a function of network connection by the user. However, when the user returns home, a consumer premise equipment (CPE) is used to provide the function of network connection by the user, and the MiFi device invisibly becomes a redundant device, thus resulting in low usage. In addition, a conventional MiFi device has a requirement for portability and low power consumption, and a conventional CPE has a requirement for high power and high-speed connectivity. These two requirements are completely different. Currently, there is a lack of mobile wireless devices and electronic devices in the market that can increase product usage, increase overall performance, and provide economical cost.

### SUMMARY

According to one aspect of the present disclosure, a mobile wireless device with expansion function is configured to connect a wireless expansion device and includes a plurality of first antennas, a wireless communication module and at least one connecting port. The wireless communication module is connected to the first antennas. The at least one connecting port is connected to the wireless communication module. The at least one connecting port is configured to be detachably connected to at least one second antenna of the wireless expansion device, so that the wireless communication module performs wireless transmission through at least a part of the first antennas and the at least one second antenna.

According to another aspect of the present disclosure, an electronic device includes a mobile wireless device with expansion function and a wireless expansion device. The mobile wireless device with expansion function includes a plurality of first antennas, a wireless communication module and at least one connecting port. The wireless communication module is connected to the first antennas. The at least one connecting port is connected to the wireless communication module. The wireless expansion device is detachably connected to the mobile wireless device with expansion function and includes at least one second antenna. The at least one connecting port of the mobile wireless device with expansion function is configured to be detachably connected to the at least one second antenna of the wireless expansion device, so that the wireless communication module performs wireless transmission through at least a part of the first antennas and the at least one second antenna.

### BRIEF DESCRIPTION OF THE DRAWINGS

The described embodiments may be better understood by reference to the following description and the accompanying drawings, in which:

FIG. 1 is a schematic block diagram view of a mobile wireless device with expansion function according to a first embodiment of the present disclosure.

FIG. 2 is a schematic view of a mobile wireless device with expansion function according to a second embodiment of the present disclosure.

FIG. 3A is a schematic front view of the mobile wireless device with expansion function as shown in FIG. 2.

FIG. 3B is a schematic side view of the mobile wireless device with expansion function as shown in FIG. 2.

FIG. 3C is a schematic rear view of the mobile wireless device with expansion function as shown in FIG. 2.

FIG. 4 is a schematic view of an electronic device according to a third embodiment of the present disclosure.

FIG. 5A is a schematic front view of a wireless expansion device of the electronic device as shown in FIG. 4.

FIG. 5B is a schematic side view of the wireless expansion device of the electronic device as shown in FIG. 4.

FIG. 5C is a schematic rear view of the wireless expansion device of the electronic device as shown in FIG. 4.

FIG. 6 is a schematic side view of the mobile wireless device with expansion function of FIG. 3B combined with the wireless expansion device of FIG. 5B to expand into an electronic device.

FIG. 7 is a schematic view of a beamforming technique of the present disclosure.

FIG. 8 is a schematic view of an expansion cooling module using metal springs of the present disclosure.

FIG. 9 is a schematic view of an expansion cooling module using balance springs of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like. The term “roughly” or “about” refers to the ability of a person having ordinary skilled in the art to address the technical issues within an acceptable range of error and achieve the fundamental technical effect.

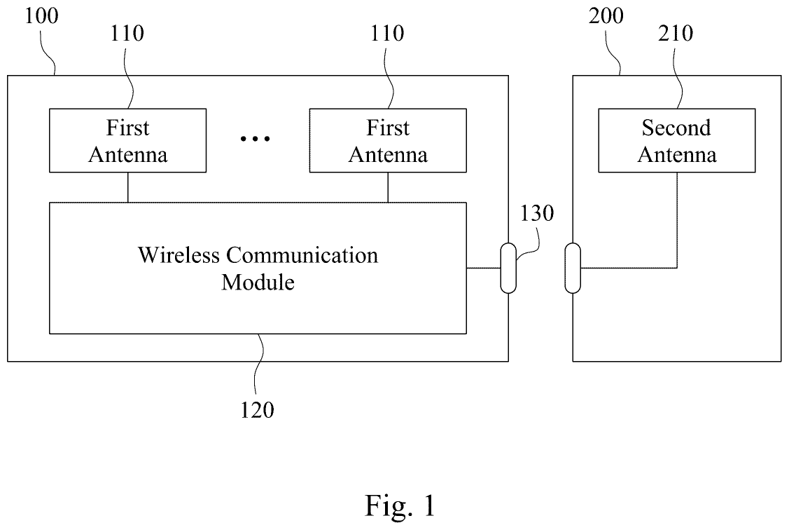

Referring to FIG. 1. FIG. 1 is a schematic block diagram view of a mobile wireless device 100 with expansion function according to a first embodiment of the present disclosure. The mobile wireless device 100 with expansion function is configured to connect a wireless expansion device 200 (Cradle) and includes a plurality of first antennas 110, a wireless communication module 120 and at least one connecting port 130. The wireless communication module 120 is connected to the first antennas 110. The at least one connecting port 130 is connected to the wireless communication module 120. The at least one connecting port 130 is configured to be detachably connected to at least one second antenna 210 of the wireless expansion device 200, so that the wireless communication module 120 performs wireless transmission through at least a part of the first antennas 110 and the at least one second antenna 210. Therefore, the mobile wireless device 100 with expansion function of the present disclosure is quite lightweight so as to allow the user to carry it easily when going out and provide a convenient network. In addition, the mobile wireless device 100 with expansion function of the present disclosure can be extendedly connected to the wireless expansion device 200 through the at least one connecting port 130, thereby not only allowing the user to use one device for multiple purposes and achieving maximum utilization, but also greatly increasing connectivity capabilities of the wireless network.

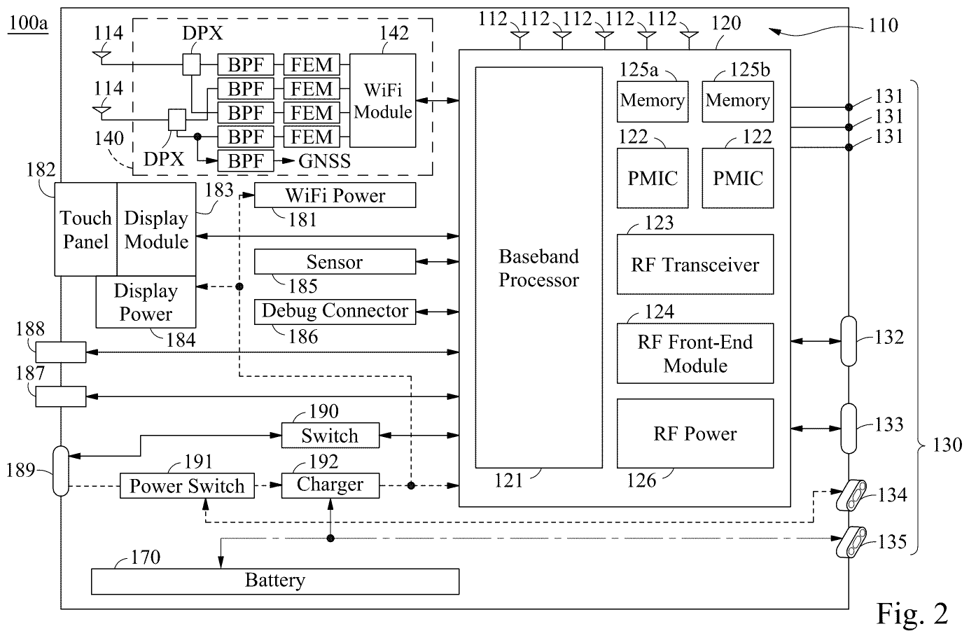

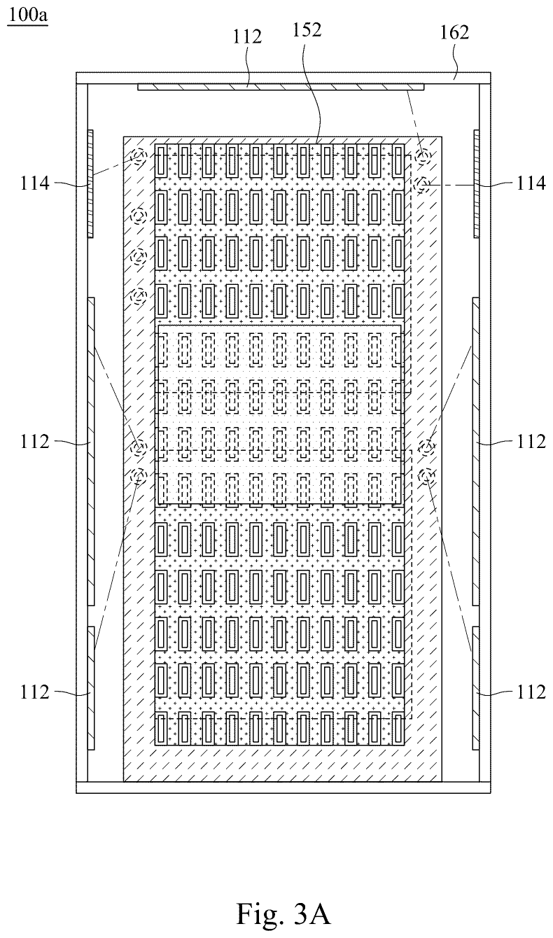

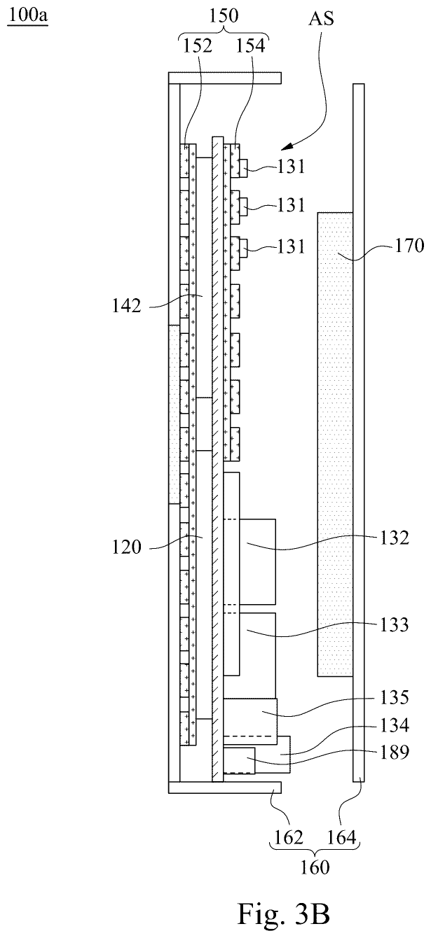

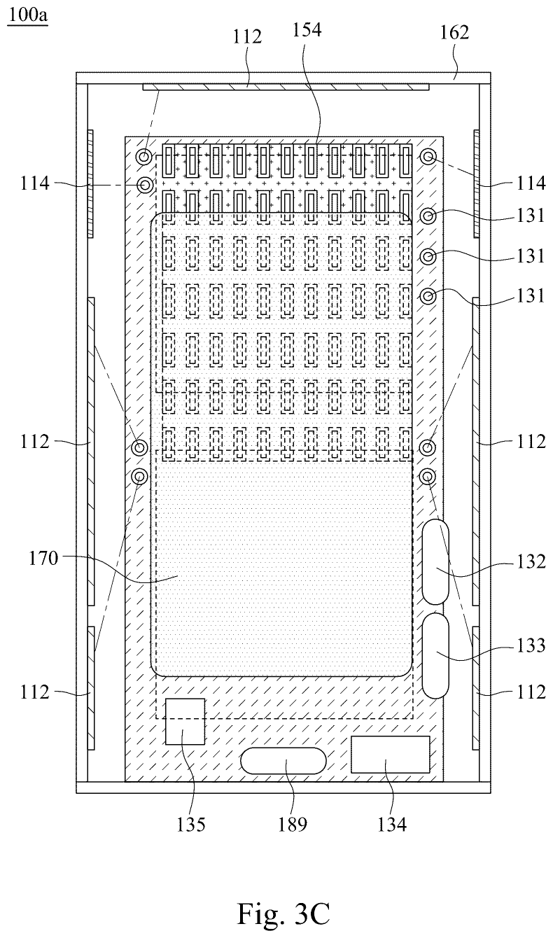

Referring to FIG. 1, FIG. 2, FIG. 3A, FIG. 3B and FIG. 3C. FIG. 2 is a schematic view of a mobile wireless device 100a with expansion function according to a second embodiment of the present disclosure. FIG. 3A is a schematic front view of the mobile wireless device 100a with expansion function as shown in FIG. 2. FIG. 3B is a schematic side view of the mobile wireless device 100a with expansion function as shown in FIG. 2. FIG. 3C is a schematic rear view of the mobile wireless device 100a with expansion function as shown in FIG. 2. The mobile wireless device 100a with expansion function is configured to connect a wireless expansion device 200 and includes a plurality of first antennas 110, a wireless communication module 120, a plurality of connecting ports 130, a WiFi unit 140, a cooling module 150, a shell 160, a battery 170 and a plurality of assemblies.

The first antennas 110 include a plurality of first cellular antennas 112 and a plurality of first WiFi antennas 114. The first cellular antennas 112 are signally connected to the wireless communication module 120. The wireless communication module 120 is compliant with a fifth generation (5G) mobile communication technology, and the first cellular antennas 112 operate in a 5G frequency band. The first WiFi antennas 114 are connected to the WiFi unit 140 and operate in a WiFi frequency band. In the embodiment, the first cellular antennas 112 may be built-in antennas, and the number of the first cellular antennas 112 may be 5. The first WiFi antennas 114 may be dual-band antennas (2.4 GHz and 5 GHz), and the number of the first WiFi antennas 114 may be 2, but the present disclosure is not limited thereto.

The wireless communication module 120 includes a baseband processor 121, two power management integrated circuits (PMICs) 122, a radio frequency (RF) transceiver 123, a RF front-end module 124, two memories 125a, 125b and a RF power 126. The baseband processor 121 provides network connection and data exchange functions. The two PMICs 122 provide stable power to the wireless communication module 120. The RF transceiver 123 provides the connection function of the 5G network. The RF front-end module 124 filters and amplifies received RF signals. The memory 125a is a flash memory (e.g., NAND 4 GB), and the memory 125b is a low-power memory (e.g., LPDDR5 16 GB). The RF power 126 provides a RF voltage.

The number of the connecting ports 130 is plural. The connecting ports 130 include a plurality of first connecting ports 131 and a second connecting port 132. The first connecting ports 131 use coaxial contact (coaxial pads) and are corresponding to a part of the second antennas 210 of the wireless expansion device 200. The second connecting port 132 is a universal serial bus type-C (USB-C) connecting port and is corresponding to the another part of the second antennas 210.

The WiFi unit 140 is connected to the wireless communication module 120 and includes a WiFi module 142, a plurality of front-end modules FEM, a plurality of band pass filters BPF and a plurality of diplexers DPX. The WiFi module 142 is connected between the wireless communication module 120 and the front-end modules FEM, and provides WiFi connection. The WiFi module 142 has an architecture of “2×2+2×2” which can provide data flows with two channels of 5 GHz and two channels of 2.4 GHz at the same time. The front-end modules FEM are connected to a part of the band pass filters BPF and are configured to amplify the RF signals. The remaining one of the band pass filters BPF is connected to a global navigation satellite system (GNSS). The band pass filters BPF is configured to filter out unwanted noise. The diplexers DPX are connected between the band pass filters BPF and the first WiFi antennas 114, and are configured to combine or separate the 2.4 GHz and 5 GHz signals.

The cooling module 150 includes a first heatsink 152 and a second heatsink 154. The first heatsink 152 is disposed on one side of the WiFi module 142 and the wireless communication module 120 to dissipate heat generated by the WiFi module 142, the front-end modules FEM and the wireless communication module 120. The second heatsink 154 is disposed on another side of the WiFi module 142 to dissipate heat generated by the WiFi module 142 and the front-end modules FEM.

The shell 160 has an accommodating space AS and includes a first housing 162 and a second housing 164. The first housing 162 is detachably connected to the second housing 164. The first antennas 110, the wireless communication module 120 and the connecting ports 130 are disposed in the accommodating space AS, and the first antennas 110 are connected to an inner side of the first housing 162.

The battery 170 is connected to the second housing 164. In response to determining that the second housing 164 is connected to the first housing 162, the battery 170 provides required power of the mobile wireless device 100a with expansion function. In response to determining that the second housing 164 together with the battery 170 is detached from the first housing 162, the connecting ports 130 are exposed to connect the wireless expansion device 200. The battery 170 is a removable lithium battery.

The assemblies include a WiFi power 181, a touch panel 182, a display module 183, a display power 184, a plurality of sensors 185, a debug connector 186, a power on button 187, a subscriber identity module holder (SIM holder) 188, a connector 189, a switch 190 (SS switch), a power switch 191 and a charger 192. The WiFi power 181 provides power to the WiFi unit 140. The touch panel 182 and the display module 183 provide touch function and display function, respectively. The display power 184 provides power to the touch panel 182 and the display module 183. The sensors 185 and the debug connector 186 are connected to the wireless communication module 120, and are configured to sense the signals and debug the signals, respectively. The power on button 187 is connected to the wireless communication module 120, and is configured to turn on or off the wireless communication module 120. The SIM holder 188 is connected to the wireless communication module 120, and is configured to install a SIM card which can be connected to a telecommunications provider network. The connector 189 is connected to the switch 190 and the power switch 191. The charger 192 is connected between the power switch 191 and the wireless communication module 120. The connector 189, the switch 190, the power switch 191 and the charger 192 are configured to provide data connection and charge for the battery 170. In the embodiment, the display module 183 can be a liquid-crystal display (LCD). The second connecting port 132, a third connecting port 133 and the connector 189 can be the USB-C connecting ports. However, the present disclosure is not limited thereto.

Therefore, the mobile wireless device 100a with expansion function of the present disclosure can be extendedly connected to the wireless expansion device 200 through the connecting ports 130, thereby not only allowing the user to use one device for multiple purposes and achieving maximum utilization, but also greatly increasing connectivity capabilities of the wireless network.

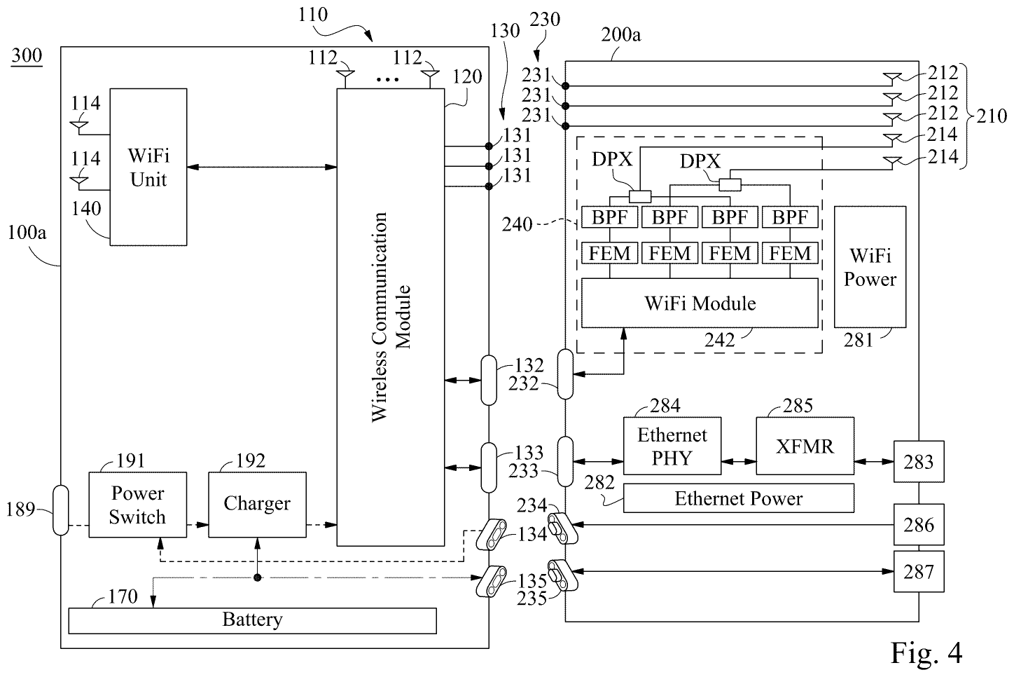

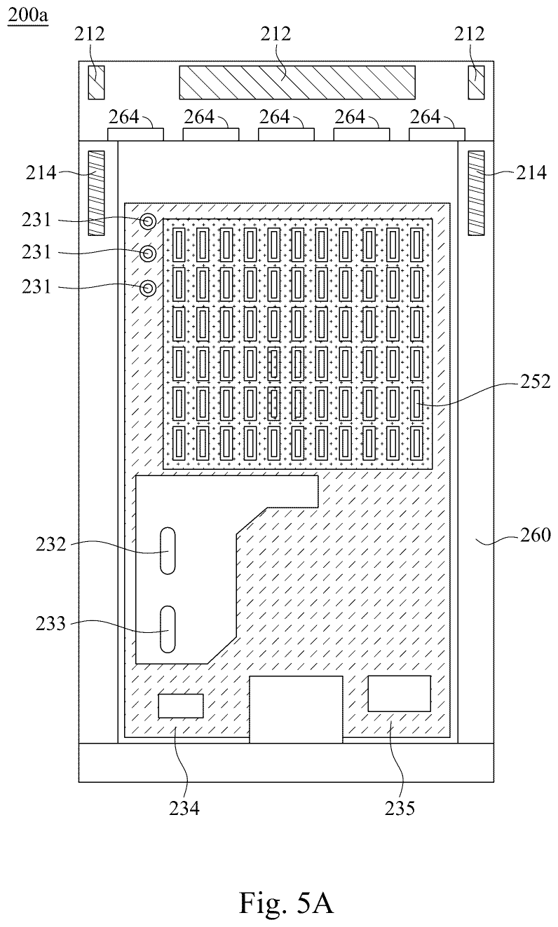

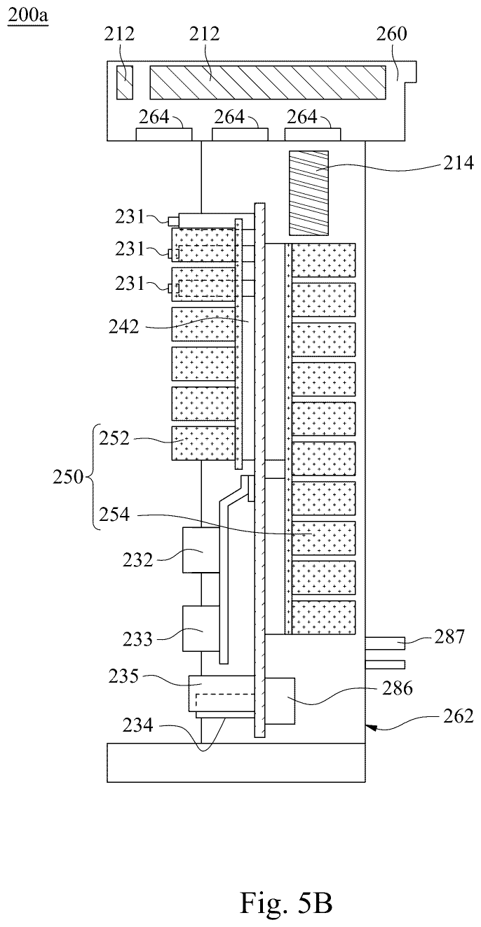

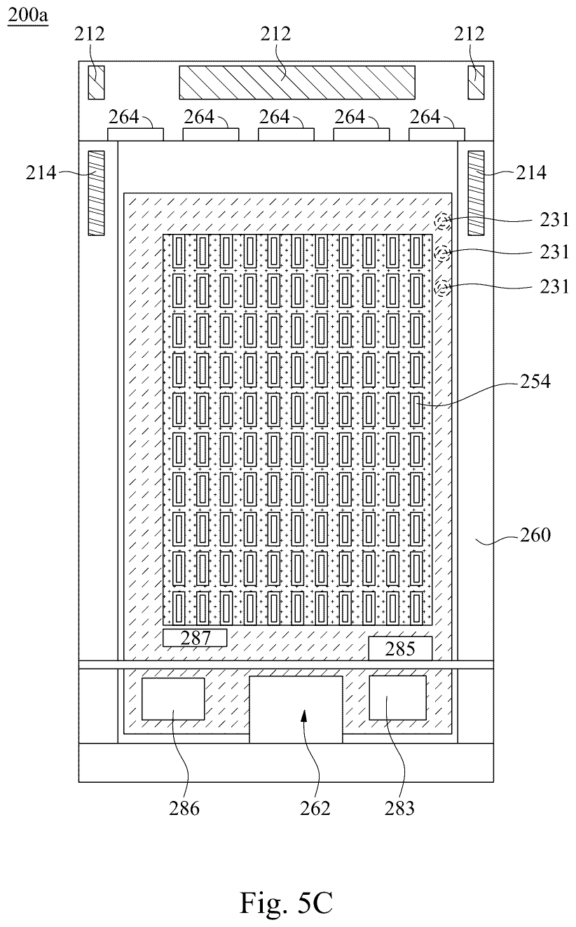

Referring to FIG. 2, FIG. 4, FIG. 5A, FIG. 5B and FIG. 5C. FIG. 4 is a schematic view of an electronic device 300 according to a third embodiment of the present disclosure. FIG. 5A is a schematic front view of a wireless expansion device 200a of the electronic device 300 as shown in FIG. 4. FIG. 5B is a schematic side view of the wireless expansion device 200a of the electronic device 300 as shown in FIG. 4. FIG. 5C is a schematic rear view of the wireless expansion device 200a of the electronic device 300 as shown in FIG. 4. The electronic device 300 includes a mobile wireless device 100a with expansion function and the wireless expansion device 200a. The structure of the mobile wireless device 100a with expansion function is the same as the structure of the mobile wireless device 100a with expansion function of FIG. 2, and the details will not be described here again. In FIG. 4, the mobile wireless device 100a with expansion function only shows the first cellular antennas 112 and the first WiFi antennas 114 of the first antennas 110, the wireless communication module 120, the connecting ports 130, the WiFi unit 140, the battery 170, the connector 189, the power switch 191 and the charger 192. The connecting ports 130 include a plurality of first connecting ports 131, a second connecting port 132, a third connecting port 133, a fourth connecting port 134 (power pogo pin) and a fifth connecting port 135 (battery pogo pin).

The wireless expansion device 200a is detachably connected to the mobile wireless device 100a with expansion function and includes at least one second antenna 210. The at least one second antenna 210 operates in at least one of the 5G frequency band and the WiFi frequency band. The connecting ports 130 of the mobile wireless device 100a with expansion function are configured to be detachably connected to the at least one second antenna 210 of the wireless expansion device 200a, so that the wireless communication module 120 performs wireless transmission through at least a part of the first antennas 110 and the at least one second antenna 210. In response to determining that the connecting ports 130 are separated from the wireless expansion device 200a, the wireless communication module 120 performs wireless transmission through the first antennas 110. On the contrary, in response to determining that the connecting ports 130 are connected to the wireless expansion device 200a, the wireless communication module 120 can cooperatively perform wireless transmission through the first antennas 110 and the at least one second antenna 210 to provide an excellent beamforming technique. The wireless expansion device 200a includes a plurality of second antennas 210, a plurality of connecting ports 230, a WiFi unit 240, an expansion cooling module 250, a shell 260 and a plurality of assemblies.

A part of the second antennas 210 operates in the 5G frequency band, and another part of the second antennas 210 operates in the WiFi frequency band. The second antennas 210 include a plurality of second cellular antennas 212 and a plurality of second WiFi antennas 214. The second cellular antennas 212 are signally connected to the wireless communication module 120 through the first connecting ports 131. The second cellular antennas 212 operate in the 5G frequency band. The second WiFi antennas 214 are signally connected to a WiFi module 242 of the WiFi unit 240 and operate in the WiFi frequency band. In other embodiments, when the second antennas operate in one of the 5G frequency band and the WiFi frequency band, connectivity capability of the corresponding frequency band can be increased.

The connecting ports 230 include another first connecting ports 231, another second connecting port 232, another third connecting port 233, another fourth connecting port 234 (power pogo pin) and another fifth connecting port 235 (battery pogo pin). The connecting ports 130 of the mobile wireless device 100a with expansion function can be correspondingly connected to the connecting ports 230 of the wireless expansion device 200a. In detail, the first connecting ports 131, 231 correspond to each other and are detachably connected to each other, so that the wireless communication module 120 can be signally connected to the second cellular antennas 212. The second connecting ports 132, 232 correspond to each other and are detachably connected to each other, so that the wireless communication module 120 can be signally connected to the second WiFi antennas 214. The third connecting ports 133, 233 correspond to each other and are detachably connected to each other. The fourth connecting ports 134, 234 correspond to each other and are detachably connected to each other. The fifth connecting ports 135, 235 correspond to each other and are detachably connected to each other.

The WiFi unit 240 includes the WiFi module 242, a plurality of front-end modules FEM, a plurality of band pass filters BPF and a plurality of diplexers DPX. The functions of the WiFi module 242, the front-end modules FEM, the band pass filters BPF and the diplexers DPX are the same as the functions of the WiFi module 142, the front-end modules FEM, the band pass filters BPF and the diplexers DPX of FIG. 2, and the details will not be described here again. The WiFi module 242 is connected to the wireless communication module 120 through the second connecting ports 132, 232, thus expanding the connection performance of WiFi.

The expansion cooling module 250 includes a third heatsink 252 and a fourth heatsink 254. The third heatsink 252 is disposed on one side of the WiFi module 242 to dissipate heat generated by the WiFi module 242 and the front-end modules FEM. The fourth heatsink 254 is disposed on another side of the WiFi module 242 to dissipate heat generated by the WiFi module 242 and the front-end modules FEM.

The second antennas 210, the connecting ports 230, the WiFi unit 240 and the expansion cooling module 250 are disposed on the shell 260. The shell 260 has at least one first opening 262 and at least one second opening 264. The at least one first opening 262 is located at one end of the shell 260, and the at least one second opening 264 is located at another end of the shell 260.

The assemblies include a WiFi power 281, an Ethernet power 282, a network connector 283 (RJ45), an Ethernet physical layer (Ethernet PHY) 284, a transformer (XFMR) 285, a power connector 286 and a battery connector 287. The WiFi power 281 provides power to the WiFi unit 240. The Ethernet power 282 provides power to the Ethernet physical layer 284 and the transformer 285. The Ethernet physical layer 284 and the transformer 285 are connected between the third connecting port 233 and the network connector 283. The Ethernet physical layer 284 provides network connection of 1 Gbps Ethernet. The transformer 285 is configured to transform signals. The power connector 286 is connected to the fourth connecting port 234, and is configured to connect an external 12 V power transformer so as to provide power to the electronic device 300. The present disclosure can provide greater power to the mobile wireless device 100a with expansion function through the power connector 286 to process more data. Moreover, the present disclosure can allow WiFi to provide greater power, thereby improving signal coverage and achieving a higher transmission rate. The battery connector 287 is connected to the fifth connecting port 235, and is configured to connect the battery 170.

In the embodiment, the mobile wireless device 100a with expansion function can be a MiFi device, and the electronic device 300 can be a CPE. The fourth connecting ports 134, 234 can be connected to each other through magnetic attraction, and the fifth connecting ports 135, 235 can also be connected to each other through magnetic attraction. The power connector 286 can be a DC connector (DC jack), and the battery connector 287 can be a spring piece (battery spring), but the present disclosure is not limited thereto.

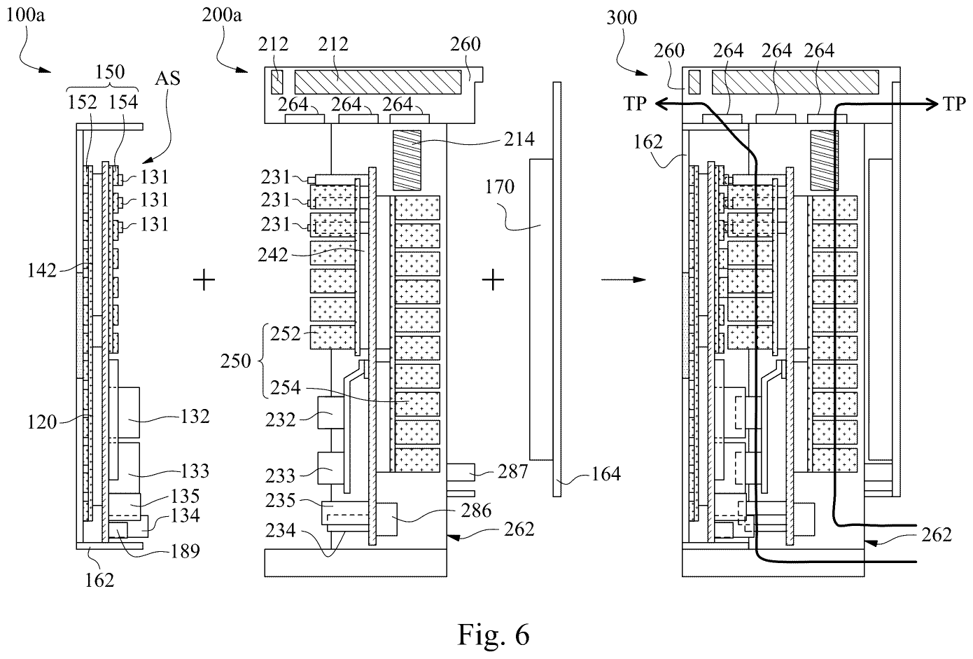

Referring to FIG. 2, FIG. 3B, FIG. 4, FIG. 5B and FIG. 6. FIG. 6 is a schematic side view of the mobile wireless device 100a with expansion function of FIG. 3B combined with the wireless expansion device 200a of FIG. 5B to expand into an electronic device 300. In response to determining that the mobile wireless device 100a with expansion function is connected to the wireless expansion device 200a, the first housing 162 and the second housing 164 of the shell 160 are engaged with two sides of the shell 260, respectively. At least one cooling path TP is formed between the at least one first opening 262 and the at least one second opening 264 to dissipate heat generated by the mobile wireless device 100a with expansion function and the wireless expansion device 200a. The electronic device 300 can be upright, so that the at least one cooling path TP forms a vertical channel. The at least one first opening 262 is located at the bottom of the at least one cooling path TP, and the at least one second opening 264 is located at the top of the at least one cooling path TP. When the component disposed inside the electronic device 300 generates heat, internal air is heated to form hot air to generate an upward airflow. The hot air can be discharged from the at least one second opening 264. At this moment, the at least one first opening 262 can suck in cold air from outside of the shell 260 to form a chimney effect so as to enhance air convection and achieve heat dissipation. The higher the heating temperature of the component is, the faster the air convection speed is, so that it is beneficial to reduce the internal temperature of the electronic device 300.

For example, when the user is outside their home and workplace, the user can use the mobile wireless device 100a with expansion function alone. The mobile wireless device 100a with expansion function includes five first cellular antennas 112 (5G antennas) and two first WiFi antennas 114 to connect to the Internet through 5G and then share it with other mobile devices (e.g., mobile phones or notebooks) through WiFi. Therefore, the user can use the Internet anytime and anywhere, and the power consumption of the battery 170 can also be reduced by using WiFi connection.

When the user is inside their home or workplace, the user can connect the mobile wireless device 100a with expansion function to the wireless expansion device 200a to expand connectivity capability. During the connection process, the mobile wireless device 100a with expansion function is first turned off. After being turned off, the battery 170 and the second housing 164 are disassembled to separate the first housing 162 and the second housing 164, and then the second housing 164 together with the battery 170 is moved to the back of the wireless expansion device 200a for charging the battery 170.

When the battery 170 and the second housing 164 are removed from the mobile wireless device 100a with expansion function, three first connecting ports 131, one second connecting port 132, one third connecting port 133, one fourth connecting port 134 and one fifth connecting port 135 are exposed, and the second heatsink 154 is also exposed to facilitate heat dissipation.

Next, the mobile wireless device 100a with expansion function is combined with the wireless expansion device 200a. Since the battery 170 and the second housing 164 are removed, and the second heatsink 154 is exposed, an internal space is extended to the entire electronic device 300 so as to increase the overall internal space. The extended internal space is more conducive to heat dissipation. Under the same power condition, the average temperature will decrease when the internal space becomes larger, so that the tolerant temperature can be more increased. In other words, under the same temperature condition, the power of WiFi can be further increased to improve signal coverage.

Therefore, the electronic device 300 of the present disclosure is based on the mobile wireless device 100a with expansion function and can be expanded into a CPE by connecting the mobile wireless device 100a with expansion function to the wireless expansion device 200a, thereby not only allowing the user to use one device for multiple purposes and achieving maximum utilization, but also greatly increasing connectivity capabilities of the wireless network. In addition, the enlargement of the space and the expansion of the cooling module 150 and the expansion cooling module 250 can enhance the overall heat dissipation capability to further increase the transmission power of the electronic device 300, thus increasing the coverage range and the connection rate.

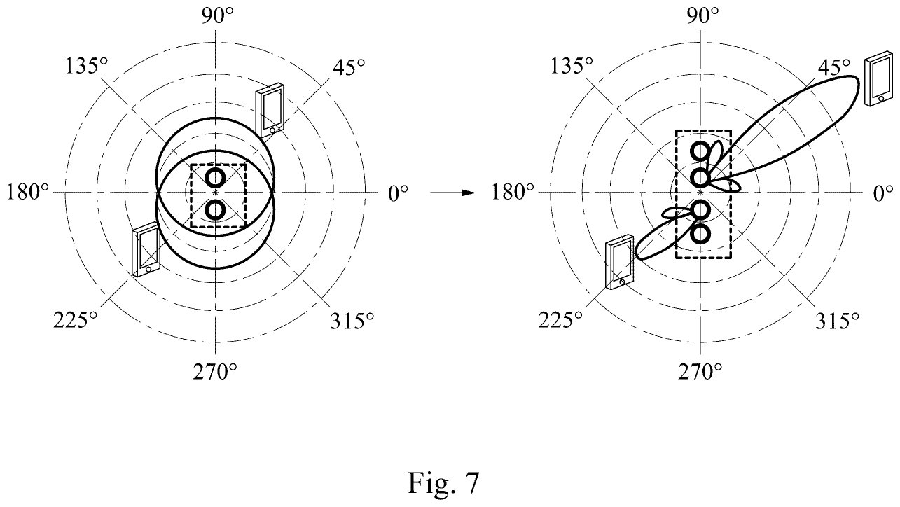

Referring to FIG. 2, FIG. 4, FIG. 6 and FIG. 7. FIG. 7 is a schematic view of a beamforming technique of the present disclosure. When the mobile wireless device 100a with expansion function is connected to the wireless expansion device 200a, the connecting ports 130 of the mobile wireless device 100a with expansion function are correspondingly connected to the connecting ports 230 of the wireless expansion device 200a. At this moment, the number of the 5G antennas will be increased from five (i.e., the five first cellular antennas 112) to eight (i.e., the five first cellular antennas 112 and three second cellular antennas 212). The number of the WiFi antennas will be increased from two (i.e., the two first WiFi antennas 114) to four (i.e., the two first WiFi antennas 114 and two second WiFi antennas 214). In addition, beamforming with four sets of antennas can be achieved to obtain longer transmission distance. Therefore, the present disclosure can increase the number of antennas by the extended connection to further provide the beamforming technique, thereby allowing WiFi to be used in a wider range and have a higher connection rate at the same time.

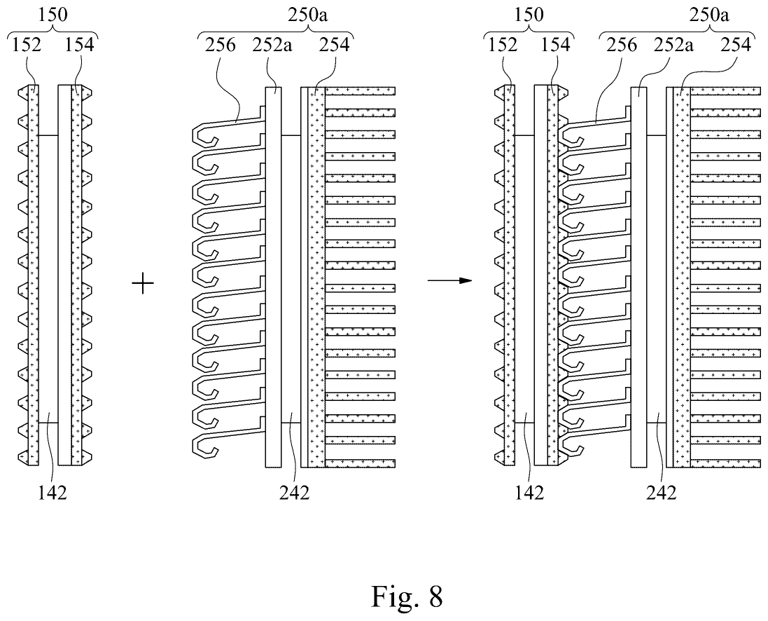

Referring to FIG. 3B, FIG. 5B, FIG. 6 and FIG. 8. FIG. 8 is a schematic view of an expansion cooling module 250a using metal springs 256 of the present disclosure. The expansion cooling module 250a includes a third heatsink 252a, a fourth heatsink 254 and a plurality of metal springs 256. The metal springs 256 are connected to the third heatsink 252a. The WiFi module 242 is connected between the third heatsink 252a and the fourth heatsink 254. In response to determining that the mobile wireless device 100a with expansion function is connected to the wireless expansion device 200a, the metal springs 256 are connected to the second heatsink 154. The metal springs 256 are made of thermally conductive elastic metal. The WiFi module 142 can enhance heat dissipation through the metal springs 256. One end of each of the metal springs 256 can be ensured to connect the second heatsink 154 with a certain pressure, thereby enhancing the heat dissipation capability of the WiFi module 142.

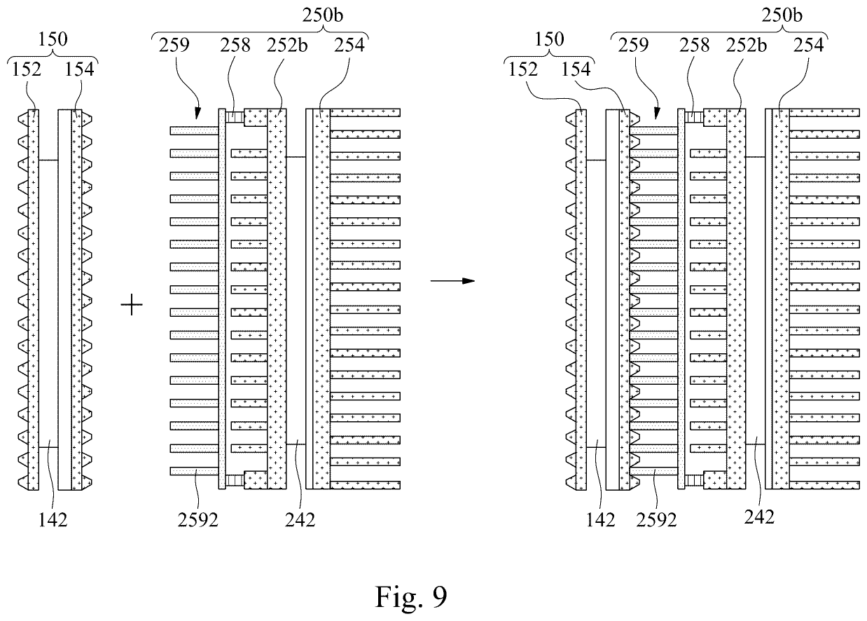

Referring to FIG. 3B, FIG. 5B, FIG. 6 and FIG. 9. FIG. 9 is a schematic view of an expansion cooling module 250b using balance springs 258 of the present disclosure. The expansion cooling module 250b includes a third heatsink 252b, a fourth heatsink 254, a plurality of balance springs 258 and a fifth heatsink 259. The balance springs 258 are connected to the third heatsink 252b and the fifth heatsink 259. The fifth heatsink 259 includes a plurality of cooling fins 2592. The WiFi module 242 is connected between the third heatsink 252b and the fourth heatsink 254. In response to determining that the mobile wireless device 100a with expansion function is connected to the wireless expansion device 200a, the cooling fins 2592 of the fifth heatsink 259 are connected to the second heatsink 154. In the embodiment, the balance springs 258 are disposed at the four corners of the third heatsink 252b, and the cooling fins 2592 to be contacted have chamfers (at the tips). When the cooling fins 2592 are contacted with the second heatsink 154, the chamfers are used to guide the cooling fins 2592 into the grooves of the second heatsink 154. The balance springs 258 can reduce a structural error to allow all of the cooling fins 2592 to smoothly contact with the second heatsink 154, thereby enhancing the heat dissipation capability of the WiFi module 142.

According to the above embodiments, the present disclosure has the following advantages. First, the present disclosure is based on the mobile wireless device with expansion function and can be expanded into a CPE by connecting the mobile wireless device with expansion function to the wireless expansion device, thereby not only allowing the user to use one device for multiple purposes and achieving maximum utilization, but also greatly increasing connectivity capabilities of the wireless network. Second, the present disclosure can enhance the overall heat dissipation capability through the extended connection of the electronic device and increase the transmission power, thus increasing the coverage range and the connection rate. Third, the present disclosure can form a chimney effect inside the electronic device through the first opening and the second opening to enhance air convection and achieve heat dissipation, so that it is beneficial to reduce the internal temperature of the electronic device.

The foregoing description of the disclosure has been presented only for the purposes of illustration and description option of the exemplary embodiments and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A mobile wireless device with expansion function, which is configured to connect a wireless expansion device, and the mobile wireless device with expansion function comprising:
a plurality of first antennas;
a wireless communication module connected to the first antennas; and
at least one connecting port connected to the wireless communication module, wherein the at least one connecting port is configured to be detachably connected to at least one second antenna of the wireless expansion device, so that the wireless communication module performs wireless transmission through at least a part of the first antennas and the at least one second antenna.

2. The mobile wireless device with expansion function of claim 1, wherein the mobile wireless device with expansion function is a mobile wireless fidelity (mobile WiFi (MiFi)) device.

3. The mobile wireless device with expansion function of claim 1, further comprising:
a WiFi module connected to the wireless communication module;
wherein the first antennas comprise:
a plurality of first cellular antennas signally connected to the wireless communication module, wherein the wireless communication module is compliant with a fifth generation (5G) mobile communication technology, and the first cellular antennas operate in a 5G frequency band; and
a plurality of first WiFi antennas signally connected to the WiFi module and operating in a WiFi frequency band.

4. The mobile wireless device with expansion function of claim 3, wherein the at least one second antenna operates in at least one of the 5G frequency band and the WiFi frequency band.

5. The mobile wireless device with expansion function of claim 4, wherein,
a number of the at least one second antenna is plural, a part of the second antennas operates in the 5G frequency band, and another part of the second antennas operates in the WiFi frequency band; and
a number of the at least one connecting port is plural, and the connecting ports comprise:
a plurality of first connecting ports using coaxial contact and corresponding to the part of the second antennas; and
a second connecting port being a universal serial bus type-C (USB-C) connecting port and corresponding to the another part of the second antennas.

6. The mobile wireless device with expansion function of claim 3, further comprising:
a cooling module, comprising:
a first heatsink disposed on one side of the WiFi module and the wireless communication module to dissipate heat generated by the WiFi module and the wireless communication module; and
a second heatsink disposed on another side of the WiFi module to dissipate heat generated by the WiFi module.

7. The mobile wireless device with expansion function of claim 1, wherein,
in response to determining that the at least one connecting port is separated from the wireless expansion device, the wireless communication module performs wireless transmission through the first antennas; and
in response to determining that the at least one connecting port is connected to the wireless expansion device, the wireless communication module performs wireless transmission through the first antennas and the at least one second antenna to provide a beamforming technique.

8. The mobile wireless device with expansion function of claim 1, further comprising:
a shell having an accommodating space and comprising a first housing and a second housing, wherein the first housing is detachably connected to the second housing, the first antennas, the wireless communication module and the at least one connecting port are disposed in the accommodating space, and the first antennas are connected to an inner side of the first housing; and
a battery connected to the second housing;
wherein in response to determining that the second housing together with the battery is detached from the first housing, the at least one connecting port is exposed to connect the wireless expansion device.

9. An electronic device, comprising:
a mobile wireless device with expansion function, comprising:
a plurality of first antennas;
a wireless communication module connected to the first antennas; and
at least one connecting port connected to the wireless communication module; and
a wireless expansion device detachably connected to the mobile wireless device with expansion function and comprising at least one second antenna;
wherein the at least one connecting port of the mobile wireless device with expansion function is configured to be detachably connected to the at least one second antenna of the wireless expansion device, so that the wireless communication module performs wireless transmission through at least a part of the first antennas and the at least one second antenna.

10. The electronic device of claim 9, wherein the mobile wireless device with expansion function is a mobile wireless fidelity (mobile WiFi (MiFi)) device, and the electronic device is a consumer premise equipment (CPE).

11. The electronic device of claim 9, wherein the mobile wireless device with expansion function further comprises:
a WiFi module connected to the wireless communication module;
wherein the first antennas comprise:
a plurality of first cellular antennas signally connected to the wireless communication module, wherein the wireless communication module is compliant with a fifth generation (5G) mobile communication technology, and the first cellular antennas operate in a 5G frequency band; and
a plurality of first WiFi antennas signally connected to the WiFi module and operating in a WiFi frequency band.

12. The electronic device of claim 11, wherein the at least one second antenna operates in at least one of the 5G frequency band and the WiFi frequency band.

13. The electronic device of claim 11, wherein a number of the at least one connecting port is plural, and the connecting ports comprise:
a plurality of first connecting ports using coaxial contact and corresponding to a part of the at least one second antenna; and
a second connecting port being a universal serial bus type-C (USB-C) connecting port and corresponding to another part of the at least one second antenna.

14. The electronic device of claim 13, wherein the wireless expansion device further comprises:
another WiFi module connected to the wireless communication module through the second connecting port;
wherein a number of the at least one second antenna is plural, and the second antennas comprise:
a plurality of second cellular antennas signally connected to the wireless communication module through the first connecting ports, wherein the second cellular antennas operate in the 5G frequency band; and
a plurality of second WiFi antennas signally connected to the another WiFi module and operating in the WiFi frequency band.

15. The electronic device of claim 11, wherein the mobile wireless device with expansion function further comprises:
a cooling module, comprising:
a first heatsink disposed on one side of the WiFi module and the wireless communication module to dissipate heat generated by the WiFi module and the wireless communication module; and
a second heatsink disposed on another side of the WiFi module to dissipate heat generated by the WiFi module.

16. The electronic device of claim 15, wherein the wireless expansion device further comprises:
another WiFi module connected to the wireless communication module through the at least one connecting port; and
an expansion cooling module, comprising:
a third heatsink disposed on one side of the another WiFi module to dissipate heat generated by the another WiFi module; and
a fourth heatsink disposed on another side of the another WiFi module to dissipate heat generated by the another WiFi module.

17. The electronic device of claim 16, wherein the expansion cooling module further comprises:
a plurality of metal springs connected to the third heatsink, wherein in response to determining that the at least one connecting port is connected to the wireless expansion device, the metal springs are connected to the second heatsink.

18. The electronic device of claim 16, wherein the expansion cooling module further comprises:
a plurality of balance springs connected to the third heatsink; and
a fifth heatsink connected to the balance springs and comprising a plurality of cooling fins, wherein in response to determining that the at least one connecting port is connected to the wireless expansion device, the cooling fins of the fifth heatsink are connected to the second heatsink.

19. The electronic device of claim 9, wherein,
the mobile wireless device with expansion function further comprises:
a shell having an accommodating space and comprising a first housing and a second housing, wherein the first housing is detachably connected to the second housing, the first antennas, the wireless communication module and the at least one connecting port are disposed in the accommodating space, and the first antennas are connected to an inner side of the first housing; and
a battery connected to the second housing; and
the wireless expansion device further comprises another shell, the another shell has at least one first opening and at least one second opening, the at least one first opening is located at one end of the another shell, and the at least one second opening is located at another end of the another shell;
wherein in response to determining that the second housing together with the battery is detached from the first housing, the at least one connecting port is exposed to connect the wireless expansion device;
wherein in response to determining that the at least one connecting port is connected to the wireless expansion device, the first housing of the shell is engaged with the another shell, and a cooling path is formed between the at least one first opening and the at least one second opening to dissipate heat generated by the mobile wireless device with expansion function and the wireless expansion device.

20. The electronic device of claim 9, wherein, in response to determining that the at least one connecting port is separated from the wireless expansion device, the wireless communication module performs wireless transmission through the first antennas; and
in response to determining that the at least one connecting port is connected to the wireless expansion device, the wireless communication module performs wireless transmission through the first antennas and the at least one second antenna to provide a beamforming technique.
